(19) United States
(12) Patent Application Publication
(10) Pub. No.: US 2015/0127660 A1
(43) Pub. Date: May 7, 2015

(54) METHOD AND APPARATUS FOR CALCULATING RANKS AND TRUST LEVELS FOR DATA SOURCES

(71) Applicant: HERE Global B.V., Veldhoven (NL)

(72) Inventors: Konstantin Zilberberg, Acton (CA); Jialing Li, Cambridge, MA (US); Tao Wu, Andover, MA (US)

(73) Assignee: HERE Global B.V., Veldhoven (NL)

(21) Appl. No.: 14/071,229

(22) Filed: Nov. 4, 2013

(51) Int. Cl. G06F 17/30

(52) U.S. Cl. CPC G06F 17/3053
USPC 707/748

(57) ABSTRACT

An approach is provided for determining one or more attributes associated with extracting data from one or more data sources. The approach further involves processing and/or facilitating a processing of the one or more attributes to cause, at least in part, a ranking of the one or more data sources, and/or a calculation of one or more trust levels for the one or more data sources.

### BACKGROUND

Service providers and device manufacturers (e.g., wireless, cellular, etc.) are continually challenged to deliver value and convenience to consumers by, for example, providing ranked and trustworthy recommendations or search results. At present, consumers have become accustomed to data that reflects real-time changes in the real world, as a result, the value of a data source is directly proportionate to its ability to provide accurate information on whichever subject they are reporting upon. With an explosion of the number of websites on all topics seemingly overnight, the challenge for users is no longer finding topical content, but instead, the challenge has become finding this content efficiently, with minimum visits or clicks to broken links or only slightly relevant websites. This growth, in turn, can make it difficult for users to sift through available content and find content of specific interest in a timely manner. Needless to mention, the volume of the information makes manual accuracy checks near-impossible, time-consuming, and costly. As a result, service providers and device manufacturers face significant technical challenges in enabling new techniques for content discovery, recommendation.

### SOME EXAMPLE EMBODIMENTS

Therefore, there is a need for an approach for processing one or more attributes associated with extracting data from one or more data sources to cause a ranking of the one or more data sources and/or calculate one or more trust levels for the one or more data sources.

According to one embodiment, a method comprises determining one or more attributes associated with extracting data from one or more data sources. The method also comprises processing and/or facilitating a processing of the one or more attributes to cause, at least in part, (a) a ranking of the one or more data sources, (b) a calculation of one or more trust levels for the one or more data sources, or (c) a combination thereof.

According to another embodiment, an apparatus comprises at least one processor, and at least one memory including computer program code for one or more computer programs, the at least one memory and the computer program code configured to, with the at least one processor, cause, at least in part, the apparatus to determine one or more attributes associated with extracting data from one or more data sources. The apparatus is also caused to process and/or facilitate a processing of the one or more attributes to cause, at least in part, (a) a ranking of the one or more data sources, (b) a calculation of one or more trust levels for the one or more data sources, or (c) a combination thereof.

According to another embodiment, a computer-readable storage medium carries one or more sequences of one or more instructions which, when executed by one or more processors, cause, at least in part, an apparatus to determine one or more attributes associated with extracting data from one or more data sources. The apparatus is also caused to process and/or facilitate a processing of the one or more attributes to cause, at least in part, (a) a ranking of the one or more data sources, (b) a calculation of one or more trust levels for the one or more data sources, or (c) a combination thereof.

According to another embodiment, an apparatus comprises means for determining one or more attributes associated with extracting data from one or more data sources. The apparatus also comprises means for processing and/or facilitating a processing of the one or more attributes to cause, at least in part, (a) a ranking of the one or more data sources, (b) a calculation of one or more trust levels for the one or more data sources, or (c) a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of processing the one or more attributes associated with extracting data from one or more data sources to cause a ranking of the one or more data sources and/or calculate one or more trust levels for the one or more data sources, according to one embodiment;

FIG. 2 is a diagram of the components of the evaluation platform 109, according to one embodiment;

FIG. 3 is a flowchart of a process for processing one or more attributes associated with extracting data from one or more data sources to cause a ranking of the one or more data sources and/or calculate one or more trust levels for the one or more data sources, according to one embodiment;

FIG. 4 is a flowchart of a process for causing, at least in part, an application of one or more parameters and/or predefined quality rules to determine one or more rankings and/or trust levels for one or more data sources, according to one embodiment;

FIG. 5 is a flowchart of a process for causing an increase or decrease in the ranking and/or the trust level of one or more data sources, and further causing a categorization of one or more data sources based, at least in part, on the ranking and/or the trust levels, according to one embodiment;

FIG. 6 is a flowchart of a process for processing of one or more data to determine accuracy of the information, and causing comparison between the data sources to generate a unified score to determine a ranking and/or trust level, according to one embodiment;

FIG. 7 is a diagram of a user interface utilized in the process of increasing or decreasing the at least one ranking and/or the at least one trust level based on the number of inaccurate information, according to one example embodiment;

FIG. 8 is a diagram of a user interface utilized in the process of increasing or decreasing the ranking of one or more data sources based, at least in part, on a determination that the data of one or more data source is accessible via a mobile communication device, according to one example embodiment;

FIG. 9 is a diagram of a user interface utilized in the process of increasing or decreasing the ranking of one or more data sources based, at least in part, on the accuracy of the retrieved data, according to one example embodiment;

FIG. 10 is a diagram of a user interface utilized in the process of increasing or decreasing the ranking of one or more data sources based, at least in part, on the timely updates and maintenance of the one or more data sources, according to one example embodiment;

FIG. 11 is a diagram of a user interface utilized in the process of increasing or decreasing the ranking of one or more data sources based, at least in part, on the parsing and/or rendering time for at least one data from one or more data sources, according to one embodiment;

FIG. 12 is a diagram of hardware that can be used to implement an embodiment of the invention;

FIG. 13 is a diagram of a chip set that can be used to implement an embodiment of the invention; and

FIG. 14 is a diagram of a mobile terminal (e.g., handset) that can be used to implement an embodiment of the invention.

### DESCRIPTION OF SOME EMBODIMENTS

Examples of a method, apparatus, and computer program for processing one or more attributes associated with extracting data from one or more data sources to cause a ranking of the one or more data sources and/or calculate one or more trust levels for the one or more data sources are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

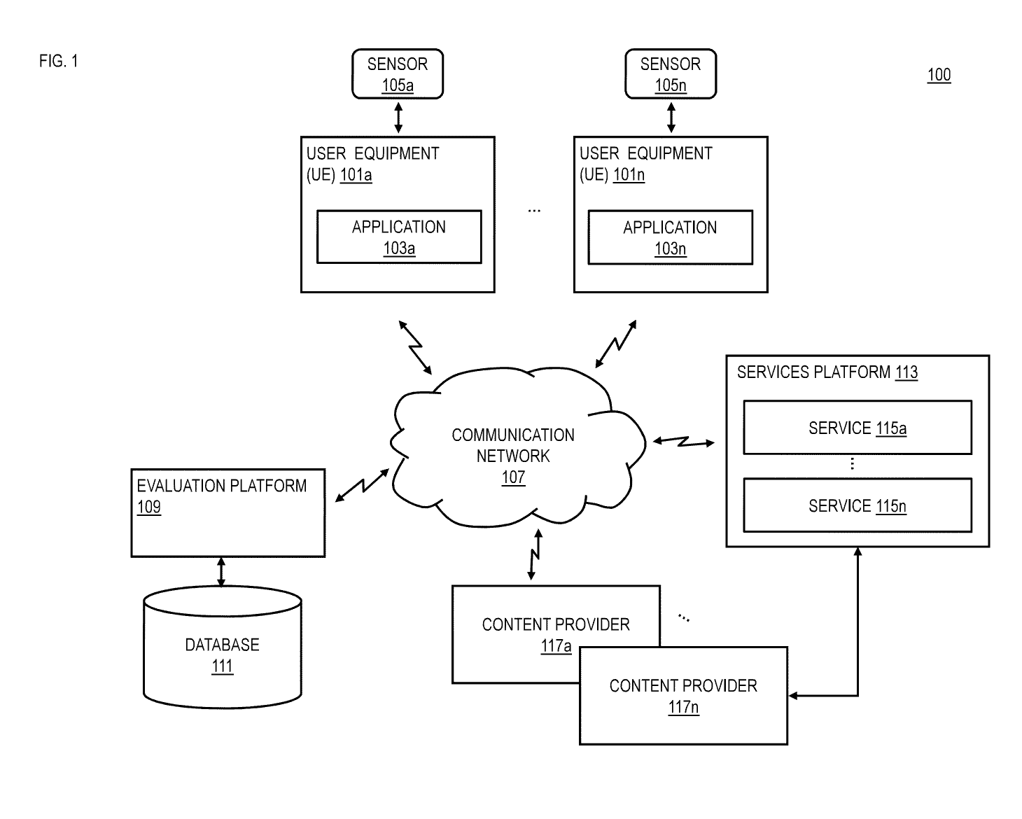

The data management process involves collecting large number of data from various data sources. However, management of the data can be problematic because of their volume and their sporadic updates. For example, data continue to grow as new records are collected and/or saved, which makes maintaining accuracy challenging. Additionally, record information, such as addresses, is rarely static, making it imperative that service providers remain vigilant in keeping the most up-to-date databases. One of the difficulties faced in the process of data management is to match and merge the extracted data from different data sources for accuracy. As a result, FIG. 1 is a diagram of a system capable of processing one or more attributes associated with extracting data from one or more data sources to generate a ranking and/or a trust levels for ensuring accuracy and relevancy of the information procured to the one or more users.

In one embodiment, a data source may be a source of information from which the system 100 may extract data, for instance, online materials, offline materials, or a combination thereof published by the at least one entity, wherein the online materials include, at least in part, at least one website of the at least one entity. In one scenario, one or more data may be a point of interest (POI) and its associated information (e.g., address, phone number, hours of operation, email, web address, fax, etc.). In one embodiment, the system 100 may aggregate and organize the data from one or more data sources to determine their accuracy and/or relevancy for causing a ranking and/or generating trust levels for the one or more data sources.

As shown in FIG. 1, the system 100 comprises user equipment (UE) 101a-101n (collectively referred to as UEs 101) that may include or be associated with applications 103a-103n (collectively referred to as applications 103) and sensors 105a-105n (collectively referred to as sensors 105). In one embodiment, the UE 101 may have connectivity to the evaluation platform 109 via the communication network 107.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the applications 103 may be any type of application that is executable at the UE 101, such as, location-based services (e.g., providing proximity information), an internet browser, media applications (e.g., music and/or video streaming, photo exchange, etc.), social networking applications, content provisioning services, and the like. In one embodiment, one of the applications 103 at the UE 101 may act as a client for the evaluation platform 109 and perform one or more functions associated with the functions of the evaluation platform 109.

By way of example, the sensors 105 may be any type of sensor. In certain embodiments, the sensors 105 may include, for example, a camera/imaging sensor for gathering image data, an audio recorder for gathering audio data, a global positioning sensor for gathering location data, a network detection sensor for detecting wireless signals or network data, temporal information and the like. In one scenario, the sensors 105 may include location sensors (e.g., GPS), light sensors, oriental sensors, tilt sensors, pressure sensors, audio sensors (e.g., microphone), or receivers for different short-range communications (e.g., Bluetooth, WiFi, etc.). In one embodiment, the sensors 105 may detect user interaction with a user interface generated by the UE 101, applications 103, and/or the evaluation platform 109.

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the evaluation platform 109 may be a platform with multiple interconnected components. The evaluation platform 109 may include multiple servers, intelligent networking devices, computing devices, components and corresponding software for processing one or more attributes associated with extracting data from one or more data sources to cause a ranking of the one or more data sources and/or calculate one or more trust levels for the one or more data sources.

In one embodiment, the evaluation platform 109 may determine one or more attributes associated with extracting data from one or more data sources. In one embodiment, the metadata may be the attributes and/or the signals associated with data extraction from one or more data sources. In one example embodiment, the evaluation platform 109 may cause, at least in part, an extraction of data from one or more data sources. Subsequently, the evaluation platform 109 may cause a ranking of data sources based, at least in part, on simplicity of the extraction process. In another example embodiment, the evaluation platform 109 causes an increase or decrease in a ranking and/or trust level based, at least in part, on one or more attributes associated with extracting data from one or more data sources.

In another embodiment, the evaluation platform 109 may process and/or facilitate a processing of the one or more attributes to cause, at least in part, (a) a ranking of the one or more data sources, (b) a calculation of one or more trust levels for the one or more data sources, or (c) a combination thereof. In one example embodiment, a website may report 123 Green Street as the address. The system 100 may extract and recognize “123 Green St.” as part of POI's address pattern following the same formula as house number, street name, and street suffix, where “123” is the house number, “Green” is the street name, and “St.” is the street suffix. The system 100 may then compare with the actual address in the database, which may have “123 Green Avenue” as the first line of the address. The system 100 may recognize that the street numbers are both “123” and the street names are both “Green.” However the system 100 may also recognize that the street suffix from the source is “St.” while the street suffix in the database record is “Avenue.” The system 100 may recognize that the street suffixes do not match. Therefore, the system 100 may determine that the data source that provides the inaccurate information of “123 Green St.” is unreliable and may lowly rank the data source and give a very low trust score. In one scenario, a web crawler may systematically crawl the internet for the purpose of gathering sources with which to verify records. According to one embodiment, the evaluation platform 109 may crawl the websites, may validate hyperlinks and Hypertext Markup Language (html) codes associated with various data sources.

In one example embodiment, the evaluation platform 109 may cause an application of predefined quality rules on the one or more attributes associated with data extraction to cause a ranking of one or more data sources. In one scenario, at least one data source may provide a user with a list of restaurants nearby user's current location, however, several of the restaurants in the list are located extremely far from the user's present location thereby rendering most of the information irrelevant, though the information provided in the list are correct. In one embodiment, the evaluation platform 109 may determine the at least one data source that provides irrelevant information to be unreliable thereby ranking them low not recommending the data source to the one or more users.

In another example embodiment, the evaluation platform 109 may determine one or more trust relationships with one or more data sources based, at least in part, on the one or more predetermined threshold value. In one scenario, the implementation of predetermined threshold value analyzes the one or more data sources which are inherently different and may determine attributes and signals associated with data extraction from one or more data sources. In one scenario, the evaluation platform 109 may create parameters on how the different data sources can be analyzed, for instance, the evaluation platform 109 may input conditions during the processing of one or more attributes associated with data extraction from one or more data sources to compute ranks and trust level.

In one embodiment, the evaluation platform 109 may include or have access to the database 111 to access or store any kind of attributes associated with extracting data from one or more data sources. In one scenario, the evaluation platform may determine accuracy of the data, relevancy of the data, proximity information, contextual information, etc. by comparing the one or more extracted data with the one or more data stored in database 111. The data stored in the database 111 may, for instance, be provided by the UE 101, the services platform 113, one or more services 115a-115n (or services 115), or one or more content providers 117a-117n (or content providers 117).

The services platform 113 may include any type of service. By way of example, the services platform 113 may include content (e.g., audio, video, images, etc.) provisioning services, application services, storage services, contextual information determination services, location based services, social networking services, information (e.g., weather, news, etc.) based services, etc. In one embodiment, the services platform 113 may interact with the UE 101, the evaluation platform 109 and content provider 117 to supplement or aid in the processing of the content information.

By way of example, services 115a-115n (hereinafter services 115) may be an online service that reflects interests and/or activities of users. In one scenario, the services 115 provide representations of each user (e.g., a profile), his/her social links, and a variety of additional information. The services 115 allow users to share media information, location information, activities information, contextual information, and interests within their individual networks, and provides for data portability. The services 115 may additionally assist in providing the evaluation platform 109 with reputation information, popularity information, social relationship information, etc.

The content provider 117 may provide content to the UE 101, the evaluation platform 109, and the services 115 of the services platform 113. The content provided may be any type of content, such as image content, video content, audio content, textual content, etc. In one embodiment, the content provider 117 may provide content that may supplement content of the applications 103, the sensors 105 or a combination thereof. By way of example, the content provider 117 may provide content that may aid in processing and/or facilitating a processing of the one or more attributes. In one embodiment, the content provider 117 may also store content associated with the UE 101, the evaluation platform 109, and the services 115 of the services platform 113. In another embodiment, the content provider 117 may manage access to a central repository of data, and offer a consistent, standard interface to data, such as a repository of users' navigational data content.

By way of example, the UE 101, the evaluation platform 109, the services platform 113, and the content provider 117 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

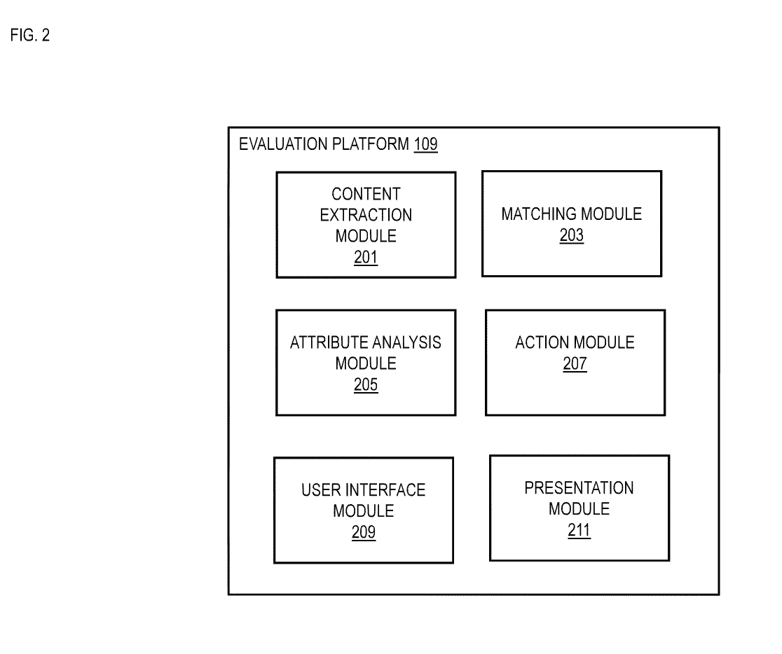

FIG. 2 is a diagram of the components of the evaluation platform 109, according to one embodiment. By way of example, the evaluation platform 109 includes one or more components for processing one or more attributes associated with extracting data from one or more data sources to cause a ranking of the one or more data sources and/or calculate one or more trust levels for the one or more data sources. It is contemplated that the functions of these components may be combined in one or more components or performed by other components of equivalent functionality. In this embodiment, the evaluation platform 109 includes a content extraction module 201, a matching module 203, an attribute analysis module 205, an action module 207, a user interface module 209, and a presentation module 211.

In one embodiment, the content extraction module 201 may extract data from the one or more data sources. The content extraction module 201 may look for clusters of data that may conform to a pattern, for example, house number, street name, street suffix, city name, state name, and zip code. In another example embodiment, the content extraction module 201 may assist the action module 207 in quantifying the extraction process, whereby the action module 207 may determine the ranking and/or the trust levels for the one or more data sources based, at least in part, on the ease of extracting data from the one or more data sources.

In one embodiment, the matching module 203 may compare the extracted data with the corresponding data record. For example, the matching module 203 may receive from the content extraction module 201 location information that may provide a street address for a particular (point of interest) POI as “123 Green Street, Wayfield, Va. 4567”. However, the location information listed in the database 111 shows the address for the POI as “123 Green Street, Wayfield, Va. 04567.” The matching module 203 may determine that a match does not exist and may submit this database 111 item with an indication that the extracted data does not match the database 111 item because the extracted location information is missing a leading zero in the zip code, and the database 111 record contains a leading zero in the zip code. In another embodiment, the matching module 203 may observe a street address is “123 Green Street,” while the database 111 item's address is listed as “123 Green St.” The matching module 203 may utilize probabilistic rules and fuzzy string matching to partial pattern matching so that it may identify that “St.” is an abbreviation of “Street.” The matching module 203 would thus determine that the extracted data matches the database 111 item.

In one embodiment, the attribute analysis module 205 determines one or more attributes associated with extracting data from one or more data sources. In one embodiment, the one or more attributes may relate to an ease of extracting the data and/or the quality of the data. In another embodiment, the quality of the one or more data may be determined based, at least in part, on the accuracy of the one or more data, the relevancy of the one or more data, the accessibility of the one or more data from at least one mobile communication device, the location proximity information, availability of product information, availability of data in different languages, or a combination thereof. In a further embodiment, the ease of extraction of one or more data may be determined based, at least in part, on the parsing pace for at least one data, the rendering speed for at least one data, or a combination thereof. By way of example, the attribute analysis module 205 may support the updating of data from one or more data sources. The attribute analysis module 205 searches for and/or retrieves data periodically or on demand. Once retrieved, the attribute analysis module 205 assists the action module 207 in ranking the data sources based on predefined quality rules. The attribute analysis module 205 may further assist the action module 207 in determining the trust level based, at least in part, on predetermined threshold value. In one scenario, the attribute analysis module 205 may determine that data from one or more data sources may be easy for machines to read, thereby indicating a strong data source that is designed to be consumed by the machines.

In one embodiment, the action module 207 may analyze the matching module's matches and determine whether the data source requires verification and/or updating. The action module 207 may first determine whether the matching module has identified a match between the extracted data from one or more data source and the database 111 item. If the matching module 203 identifies a match, then the action module 207 may generate a score for causing a ranking and/or trust levels for the one or more data sources. In another embodiment, the action module 207 may penalize one or more data sources if the matching module 203 reports that the extracted data does not match the database 111 items. In another embodiment, the action module 207 may match the relevancy of the extracted data with the query of the one or more users, thereby generating a ranking and/or trust levels based, at least in part, on the relevancy factor.

In one embodiment, the user interface module 209 enables presentation of one or more data extracted from one or more data sources. The user interface module 209 employs various application programming interfaces (APIs) or other function calls corresponding to the application 103 of UE 101; thus enabling the display of graphics primitives such as menus, data entry fields, etc., for generating the user interface elements. By way of example, the user interface module 209 generates the interface in response to application programming interfaces (APIs) or other function calls corresponding to the browser application or web portal application of the UE 101; thus enabling the display of graphics primitives.

In one embodiment, the presentation module 211 causes a display of at least one list of one or more data sources based, at least in part, on the processing of the one or more attributes of data extracted from one or more data sources. In another embodiment, the presentation module 211 may cause a presentation of one or more ranking and/or trust levels for the one or more data sources based, at least in part, on the ease of extracting the data from the data sources, the quality of the data, or a combination thereof. In a further embodiment, the presentation module 211 obtains a set of summary statistics from the other modules. Then, the presentation module 211 continues with generating a presentation corresponding to the inquiry of the at least one user. Then, continues with providing of presentation of a data set where the presentation could be depicted in one or more visual display units.

The above presented modules and components of the evaluation platform 109 can be implemented in hardware, firmware, software, or a combination thereof. Though depicted as a separate entity in FIG. 1, it is contemplated that the evaluation platform 109 may be implemented for direct operation by respective UE 101. As such, the evaluation platform 109 may generate direct signal inputs by way of the operating system of the UE 101 for interacting with the application 103. In another embodiment, one or more of the modules 201-211 may be implemented for operation by respective UEs, as an evaluation platform 109. Still further, the evaluation platform 109 may be integrated for direct operation with services 115, such as in the form of a widget or applet, in accordance with an information and/or subscriber sharing arrangement. The various executions presented herein contemplate any and all arrangements and models.

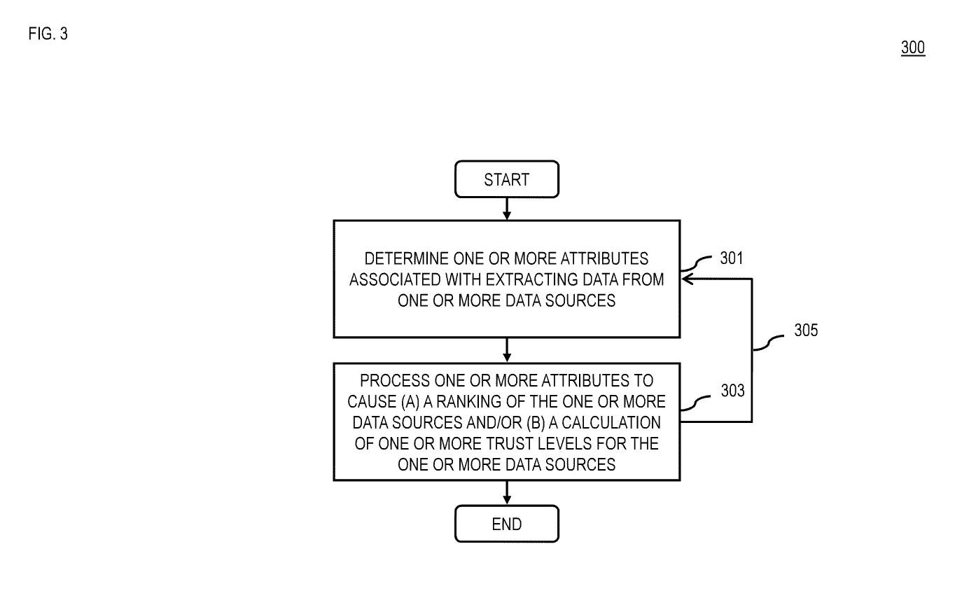

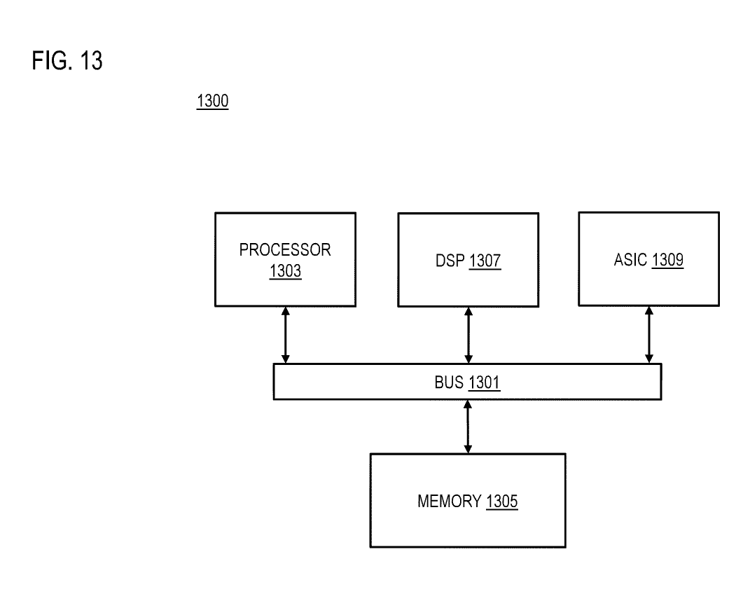

FIG. 3 is a flowchart of a process for processing one or more attributes associated with extracting data from one or more data sources to cause a ranking of the one or more data sources and/or calculate one or more trust levels for the one or more data sources, according to one embodiment. In one embodiment, the evaluation platform 109 performs the process 300 and is implemented in, for instance, a chip set including a processor and a memory as shown in FIG. 13.

In step 301, the evaluation platform 109 determines one or more attributes associated with extracting data from one or more data sources, wherein the one or more attributes relate, at least in part, to an ease of extracting the data from the data sources, a quality of the data, or a combination thereof. In one embodiment, the metadata may be the attributes and/or the signals associated with data extraction from one or more data sources. In one scenario, the evaluation platform 109 may extract data from one or more data sources, and cause a ranking for one or more data sources based on the ease of the data extraction process. In one example embodiment, the evaluation platform 109 may conduct data extraction to parse out location information, for instance, the house number, street name, street suffix, and the zip code. The evaluation platform 109 may identify the house number as the first component of an address, usually composed of a number. Further, the evaluation platform 109 may distill the street name as the second component of an address and the zip code as the last component of an address, usually composed of five numbers. Subsequently, the evaluation platform 109 may rank the data sources based, at least in part, on how efficiently the extracted data can be parsed. A complex metadata takes more time and resource, and contribute to negative user experience and interaction. Since, large number of metadata are collected when collecting information from one or more data sources, the evaluation platform 109 may cause efficient processing of these metadata to develop ranking and/or trust levels to provide more accurate results. In one scenario, the one or more data may be parsed through the html code to see how good the data is, for instance, checking for misspelling in general.

In step 303, the evaluation platform 109 processes and/or facilitates a processing of the one or more attributes to cause, at least in part, (a) a ranking of the one or more data sources, (b) a calculation of one or more trust levels for the one or more data sources, or (c) a combination thereof. In one scenario, the evaluation platform 109 provides at least one search results that are ranked according to a measure of trust. For instance, at least one user may provide a query to the evaluation platform 109 whereby the evaluation platform may retrieve a set of search results relevant to the query. The evaluation platform 109 may determine trust level for each data source in the search item, and may apply the trust factor to adjust the order in which the data sources are presented. In one scenario, the evaluation platform 109 may re-rank the one or more data sources in a search result based, at least in part, on the determined trust level, thereby providing more specific result. In one embodiment, a high trust level for a data source may impact its ranking Similarly, a lowly ranked data source may not have a high trust level. Therefore, the evaluation platform 109 may provide at least one user with a list of data source that are ranked in accordance with their trust score.

In step 305, the evaluation platform 109 may cause the one or more rankings and/or trusts levels determination for one or more data sources to be a continuous process, wherein the need for constant monitoring may be implemented on the cloud based data harvesting system. In one embodiment, the cloud based data harvesting system may provide required elasticity, for instance, an on demand processing power and virtually unlimited storage for extracting and processing the one or more data, efficiently.

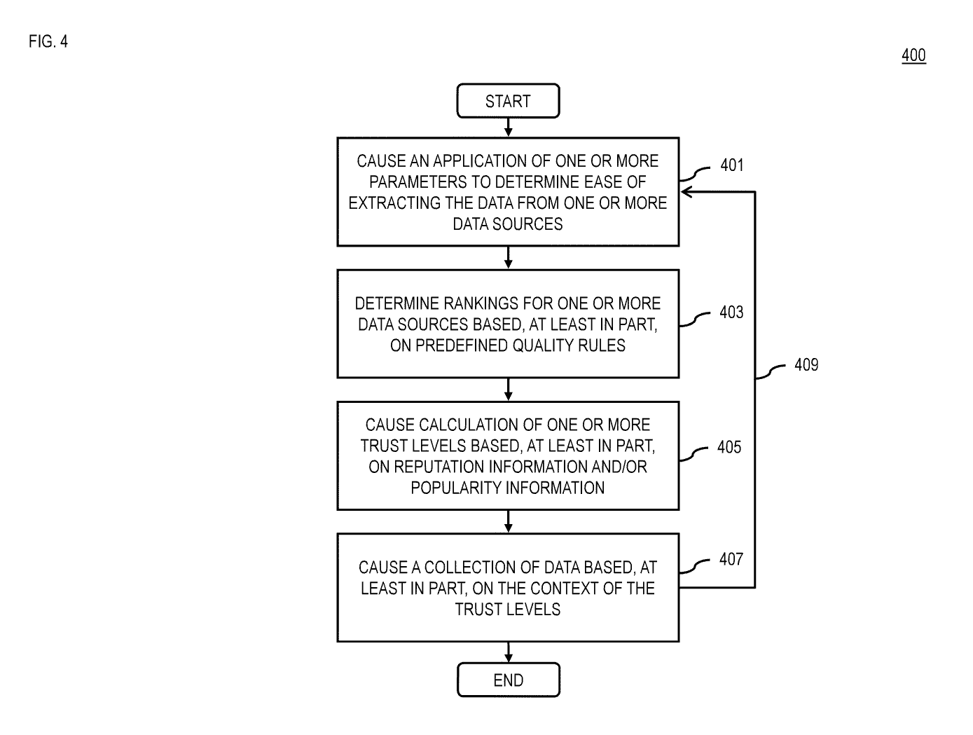

FIG. 4 is a flowchart of a process for causing, at least in part, an application of one or more parameters and/or predefined quality rules to determine one or more rankings and/or trust levels for one or more data sources, according to one embodiment. In one embodiment, the evaluation platform 109 performs the process 400 and is implemented in, for instance, a chip set including a processor and a memory as shown in FIG. 13.

In step 401, the evaluation platform 109 causes, at least in part, an application of one or more parameters to determine ease of extracting the data from one or more data source, wherein one or more parameters include, at least in part, a parsing speed for one or more data, a rendering speed for one or more data, or a combination thereof. In one scenario, the evaluation platform 109 may analyze data into different parts in order to understand their meaning and relationship, wherein one or more data may be sequentially partitioned to represent their attributes and/or signals. Subsequently, the evaluation platform 109 may take into consideration the parsing speed to determine the ease of extracting the data from one or more data sources. The parsing speed may affect the ranking for one or more data sources. In another example embodiment, the evaluation platform 109 may take into consideration the rendering speed, for instance, a website speed may be slower for complex and large websites, and connectivity issues. Such rendering speed may be reflected in the ranking of the one or more data sources.

In step 403, the evaluation platform 109 determines, at least in part, rankings for one or more data sources based, at least in part, on predefined quality rules, wherein predetermined quality rules include, at least in part, accuracy of the one or more data, the relevancy of the one or more data, timely updates of the one or more data sources, or a combination thereof. In one example embodiment, the accuracy of the information provided by the one or more data sources may affect their rank and trust level. In another example embodiment, the evaluation platform 109 may determine that the one or more data may be accurate but not relevant to the query of the at least one user. In one scenario, the evaluation platform 109 may assign weight to one or more sources based, at least in part, on their accuracy and reliability. A website with irrefutable evidence of information may be given the greatest weight of five out of five, for instance, a website that provides accurate and relevant information. On the other hand, another website may be assigned a slightly lower weight of three out of five because the information though accurate are less relevant. Subsequently, the weight given to one or more data sources influences the ranking and/or trust levels. In one scenario, linkages between one or more data sources may be an indicator on the popularity and reliability of the data source. The more widespread a data sources is, the more reliable it may be.

In step 405, the evaluation platform 109 causes, at least in part, calculation of one or more trust levels based, at least in part, on reputation information, popularity information, or a combination thereof. In one scenario, the evaluation platform 109 may take into consideration various factors for determining a trust level for one or more data sources, for instance, the frequency of visits by one or more users to the at least one data source, the reviews given by one or more users on the at least one data source, the number of views received by the at least one data source from one or more users, or a combination thereof.

In step 407, the evaluation platform 109 causes, at least in part, a collection of data based, at least in part, on the context of the trust levels. In one scenario, the evaluation platform 109 may determine to collect data from data sources with high trust levels, such data processing from selected data sources is more efficient. In another scenario, the difficulty level of extracting data from one or more data sources makes it little trustworthy and lowly ranked, such factors effects the trust score.

In step 409, the evaluation platform 109 may cause a continuous application of one or more parameters and/or predefined quality rules to determine one or more rankings and/or trust levels for one or more data sources. In one scenario, the evaluation platform 109 may implement a cloud based data harvesting system that may provide an on demand processing power for efficient data extraction and data processing, thereby enabling the evaluation platform 109 to suitably update the one or more ranking and/or trust levels for one or more data sources.

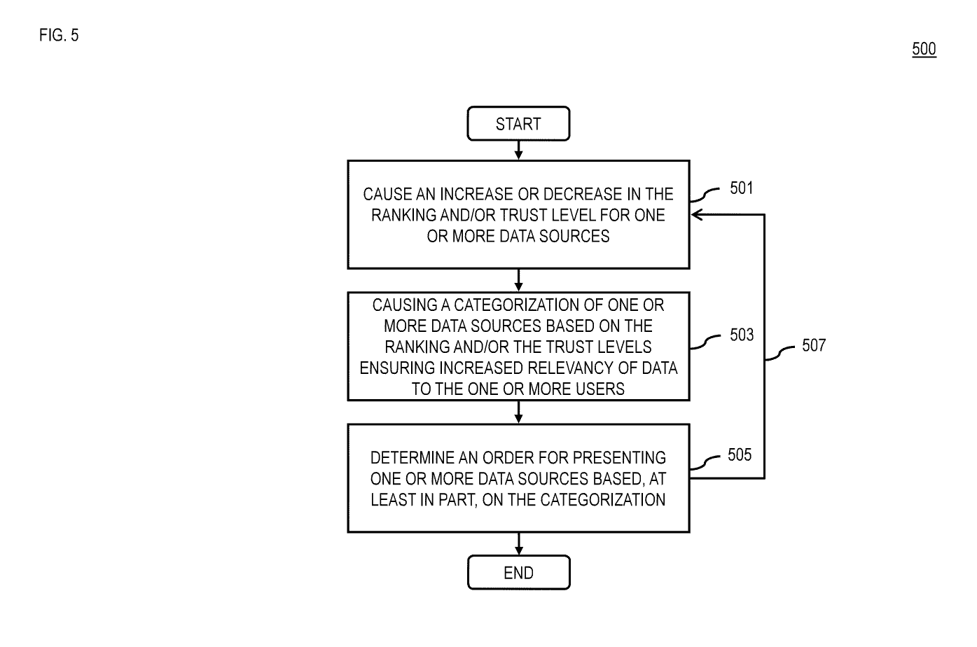

FIG. 5 is a flowchart of a process for causing an increase or decrease in the ranking and/or the trust level of one or more data sources, and further causing a categorization of one or more data sources based, at least in part, on the ranking and/or the trust levels, according to one embodiment. In one embodiment, the evaluation platform 109 performs the process 500 and is implemented in, for instance, a chip set including a processor and a memory as shown in FIG. 13.

In step 501, the evaluation platform 109 causes, at least in part, an increase or a decrease in a ranking, a trust level, or a combination thereof based, at least in part, on occurrence of inaccurate information, retrieval of one or more data from at least one mobile device, location proximity information, contextual information, or a combination thereof. In one scenario, the metadata created during the extraction of data from one or more data sources may be unreadable and is not supported by UE 101. The accessibility of data from one or more data sources via a UE 101 increases their rank because many people wishes to access data sources via their UE 101. In one scenario, at least one data source may have a native mobile application but may not have a desktop version, wherein the evaluation platform 109 may compare the accessibility of data to determine a score for ranking and/or trust level. In one example embodiment, one or more data tailored to different languages, the integration of one or more features for personalization of the data, the incorporation of user interfaces and programs that are universally accepted, or a combination thereof, may be taken into consideration by the evaluation platform 109 during generation of rankings and/or trust level. In another example embodiment, the evaluation platform 109 may recognize the location for the at least one user, for instance, the user may be in AXY city whereby the search may be limited to the area within or nearby AXY City. In one scenario, by doing so the evaluation platform 109 recognizes the difficulty in extraction of data from several data sources. In a further example embodiment, the evaluation platform 109 may determine ranking and/or trust level for one or more data sources based, at least in part, on the availability of product information, for instance, price, quantity, brands etc.

In step 503, the evaluation platform 109 causes, at least in part, a categorization of one or more data sources based, at least in part, on the ranking, the trust levels, or a combination thereof ensuring increased relevancy of data to the one or more users. In one embodiment, the evaluation platform 109 may classify data as more accurate and relevant upon extracting and matching the one or more data with various other sources. For example, if one or more website lists location information for ABC Palace as “123 CXS Street”, the evaluation platform may utilize ABC Palace's website alongside other sources to determine POI address accuracy. The evaluation platform 109 may rank and/or generate trust levels based on the accuracy of the location information. Subsequently, the evaluation platform 109 may categorize the one or more website with correct information based on the ranking and/or trust levels.

In step 505, the evaluation platform 109 determines an order for presenting one or more data sources based, at least in part, on the categorization. In one scenario, the higher the level of accuracy and relevancy, the higher is the rank and the trust level. In another scenario, after the one or more data sources are categorized, the order for presenting the one or more data sources in the category is further based on the rank and/or trust level.

In step 507, the adjustment process in the ranking and/or the trust level for one or more data sources may be periodic, and the categorization of the one or more data sources may be further based on such periodic adjustment in the ranking and/or the trust levels. In one scenario, the evaluation platform 109 may employ a cloud based data harvesting system that may provide an on demand processing power and unlimited storage for efficient update of the one or more ranking and/or trust levels for one or more data sources. In one scenario, a cloud based data harvesting system may provide the evaluation platform 109 with the ability to provide constantly fresh and updated information adjusted to the ongoing changes.

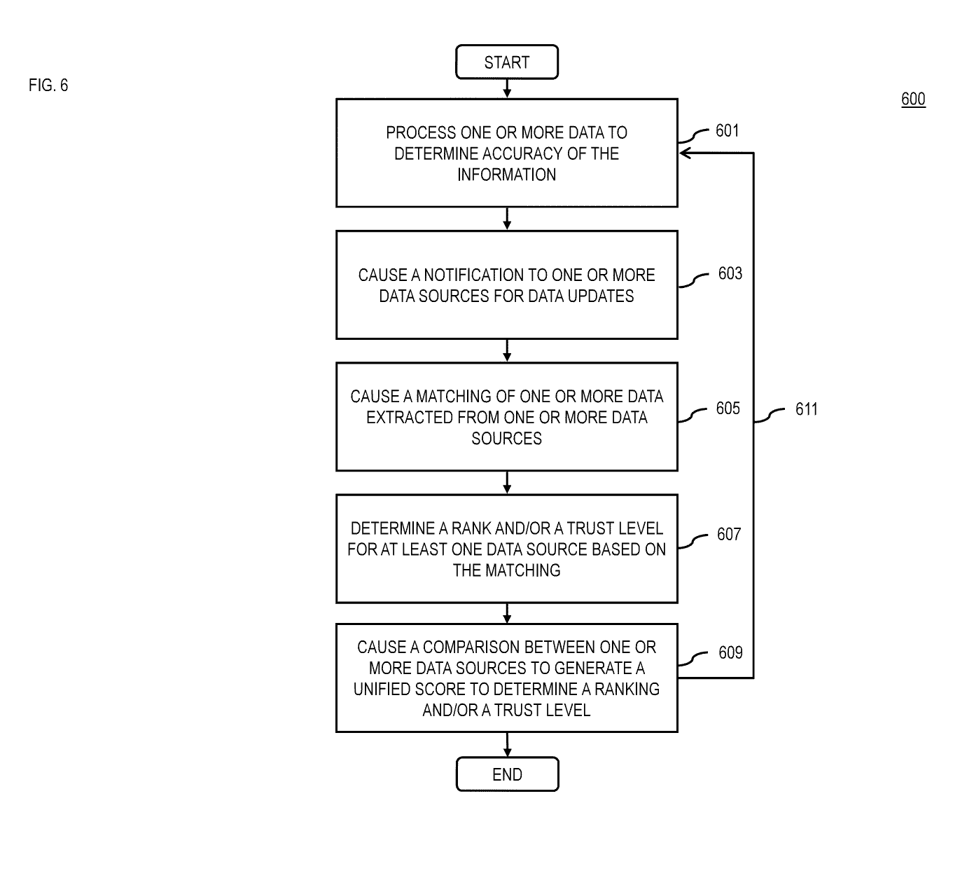

FIG. 6 is a flowchart of a process for processing of one or more data to determine accuracy of the information, and causing comparison between the data sources to generate a unified score to determine a ranking and/or trust level, according to one embodiment. In one embodiment, the evaluation platform 109 performs the process 600 and is implemented in, for instance, a chip set including a processor and a memory as shown in FIG. 13.

In step 601, the evaluation platform 109 processes and/or facilitates a processing of one or more data to determine accuracy of the information. For example, one or more data sources may list numerous locations for ZXC bank including locations that are no longer in operation. Here, the evaluation platform 109 may process the one or more data to determine accurate information, it may reward data sources with high rankings and trust scores for procuring accurate information. On the other hand, the evaluation platform 109 may penalize one or more data sources for providing wrong information to the one or more users.

In step 603, the evaluation platform 109 causes, at least in part, a notification to one or more data sources for data updates. In one embodiment, the evaluation platform 109 may alert one or more data sources having incorrect information to update their data. In one embodiment, the evaluation platform 109 may categorize one or more data sources with incorrect information as inferior sources, and may not refer such sources to the users. In another embodiment, the evaluation platform 109 may inspect the inferior sources on a regular basis and/or on demand, thereby revising the records for one or more ranking and/or trust levels.

In step 605, the evaluation platform 109 causes, at least in part, a matching of one or more data extracted from one or more data sources. In one embodiment, the evaluation platform 109 matches the one or more data extracted from the at least one data source with other data sources to determine how well the sources match. In another scenario, the process of matching may involve incorporation of data with the core database and/or standardizing the one or more data format to incorporate with the core database.

In step 607, the evaluation platform 109 determines a rank, a trust level, or a combination thereof for at least one data source based, at least in part, on the matching. In one scenario, the evaluation platform 109 may determine that the one or more extracted data matches with other data sources and is accurate. Subsequently, the evaluation platform 109 may rank and create trust level for the data source based, at least in part, on the determination.

In step 609, the evaluation platform 109 causes, at least in part, a comparison between one or more data sources to generate a unified score to determine a ranking, a trust level, or a combination thereof. In one scenario, the evaluation platform 109 may determine scores for one or more data sources based on metadata quality, trust relationships etc.

In step 611, the evaluation platform 109 may cause an uninterrupted processing of the one or more extracted data to determine their accuracy, and may cause one or more comparisons between the data sources to determine a ranking and/or trust level based, at least in part, on the continuous processing.

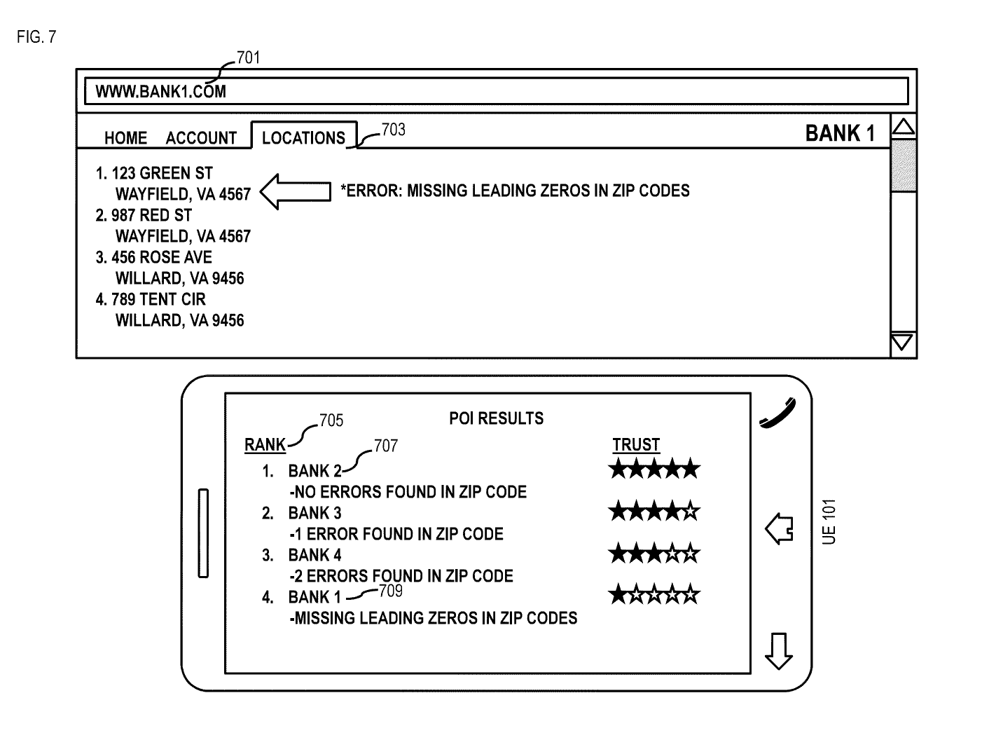

FIG. 7 is a diagram of a user interface utilized in the process of increasing or decreasing the at least one ranking and/or the at least one trust level based on the number of inaccurate information, according to one example embodiment. In one embodiment, the evaluation platform 109 may determine an error in one or more attributes associated with extracting data from one or more data sources. In one scenario, the evaluation platform 109 may determine error in location information (703) provided by the at least one data source (701), for instance, the location information is incomplete (703). Subsequently, the evaluation platform 109 upon determining errors in a data source may cause a decrease in the rank and/or the trust level (705). In one scenario, the evaluation platform 109 determines that the location information provided by a website has incorrect zip code (701), for instance, the zip codes is missing the leading zero (703), therefore making it difficult for one or more users to find the location. As a result, the value of the location information is reduced because neither can the information be used to correctly navigate the one or more users to their destination, nor can the user share the information. In such manner, the signal for the evaluation platform 109 is to determine whether the address from at least one data source, for instance, a website, has errors, if so, how many. In one scenario, the evaluation platform 109 may cause a presentation of one or more data sources in a UE 101 based, at least in part, on the number of errors in the data provided by the one or more data source. In one scenario, the data source for Bank 2 may be highly ranked (707) than the data source for Bank 3, Bank 4 and Bank 1 because the procured data is accurate and is free from any errors. Similarly, the data sources may be ranked in order of their mistakes, wherein data source with accurate information are highly ranked (707), and data sources with mistakes in their data are lowly ranked (709).

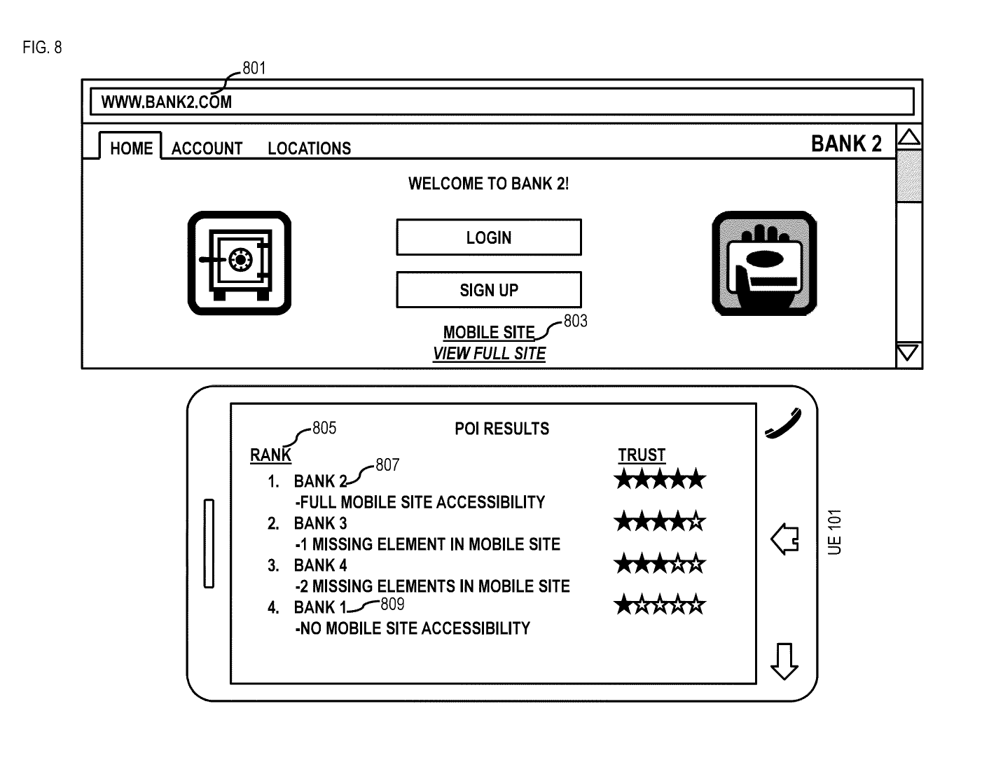

FIG. 8 is a diagram of a user interface utilized in the process of increasing or decreasing the ranking of one or more data sources based, at least in part, on a determination that the data of one or more data source is accessible via a mobile communication device, according to one example embodiment. In one scenario, the evaluation platform 109 upon determination that the at least one data source has a mobile version of the web page may cause an increase in the ranking and/or the trust level of the data source. In one scenario, the evaluation platform 109 may determine that data of at least one data source, for instance, Bank 2 (801), is accessible through one or more mobile communication device (803). Subsequently, the evaluation platform 109 may cause a ranking of the data sources on the basis of the determination (805). In one scenario, the evaluation platform 109 may rank Bank 2 higher than Bank 3, Bank 4 and Bank 1 because the Bank 2 has full mobile site accessibility (807). Similarly, the evaluation platform 109 may rank Bank 1 the lowest because Bank 1 has no mobile accessibility (809). In this manner, the evaluation platform 109 recognizes the importance of having a mobile version for one or more data sources to allow users to access data from a mobile communication device.

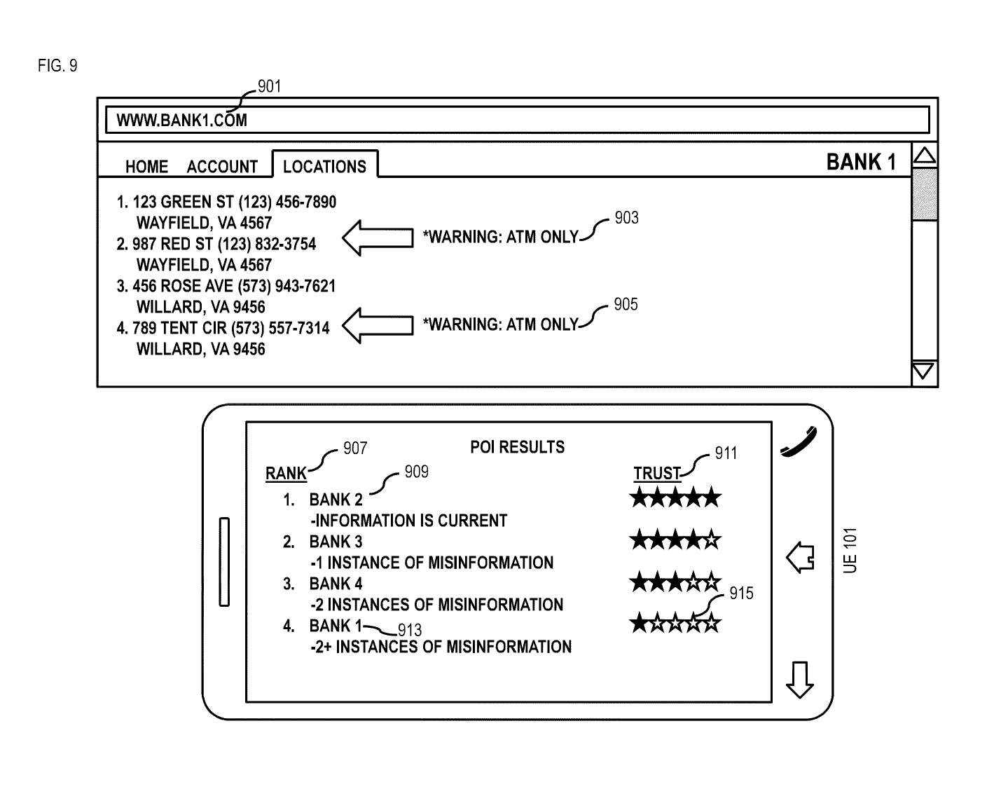

FIG. 9 is a diagram of a user interface utilized in the process of increasing or decreasing the ranking of one or more data sources based, at least in part, on the accuracy of the retrieved data, according to one example embodiment. In one scenario, the evaluation platform 109 may determine that the location data for Bank 1 (901) contains location information even for locations that only has Automated Teller Machine (ATM) (903, 905). The evaluation platform 109 may cause a ranking based on the accuracy of the location information (907). In one scenario, the evaluation platform 109 encourages data sources to have complete information, as a result, the ranking and/or trust levels for data sources is higher for the ones with accurate and complete data information. In one scenario, the data source for Bank 2 is highly ranked because the location data is current and is timely updated (909). In another scenario, a highly ranked data source may have a high trust level, vice versa (911). In a similar manner, Bank 1 is lowly ranked (913) with a low trust level (915) because the instance of misinformation is high.

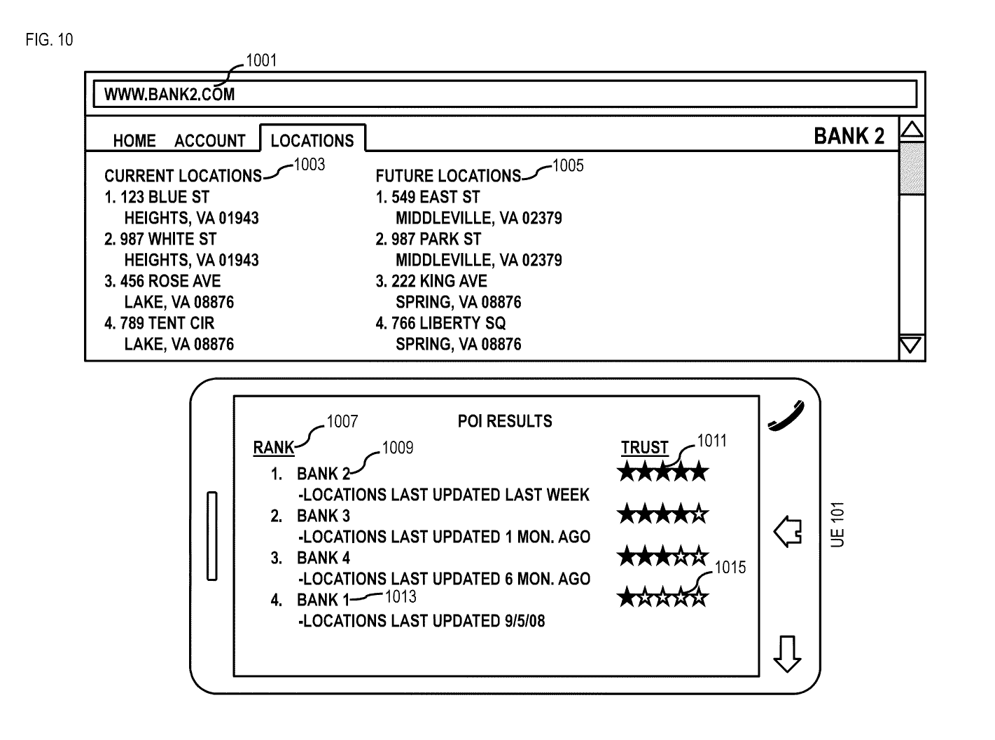

FIG. 10 is a diagram of a user interface utilized in the process of increasing or decreasing the ranking of one or more data sources based, at least in part, on the timely updates and maintenance of the one or more data sources, according to one example embodiment. In one scenario, the data source for Bank 2 (1001) may list current location information (1003) alongside future location information (1005) that may open soon. In one scenario, the inclusion of future location information may imply that the data source is maintained and updated on a regular basis. In one scenario, the evaluation platform 109 may highly rank the data sources that are updated and maintained on a timely manner (1007). Similarly, the evaluation platform 109 may rank Bank 2 higher in comparison to Bank 3, Bank 4 and Bank 1 because the data source for Bank 2 was most recently updated (1009). The evaluation platform 109 may determine that the data source with recently updated information is more trustworthy, henceforth Bank 2 gets higher trust score (1011). On the other hand, Bank 1 is poorly ranked (1013) and receives the lowest trust score (1015) because the location data has not been updated for several years, and may be considered unreliable.

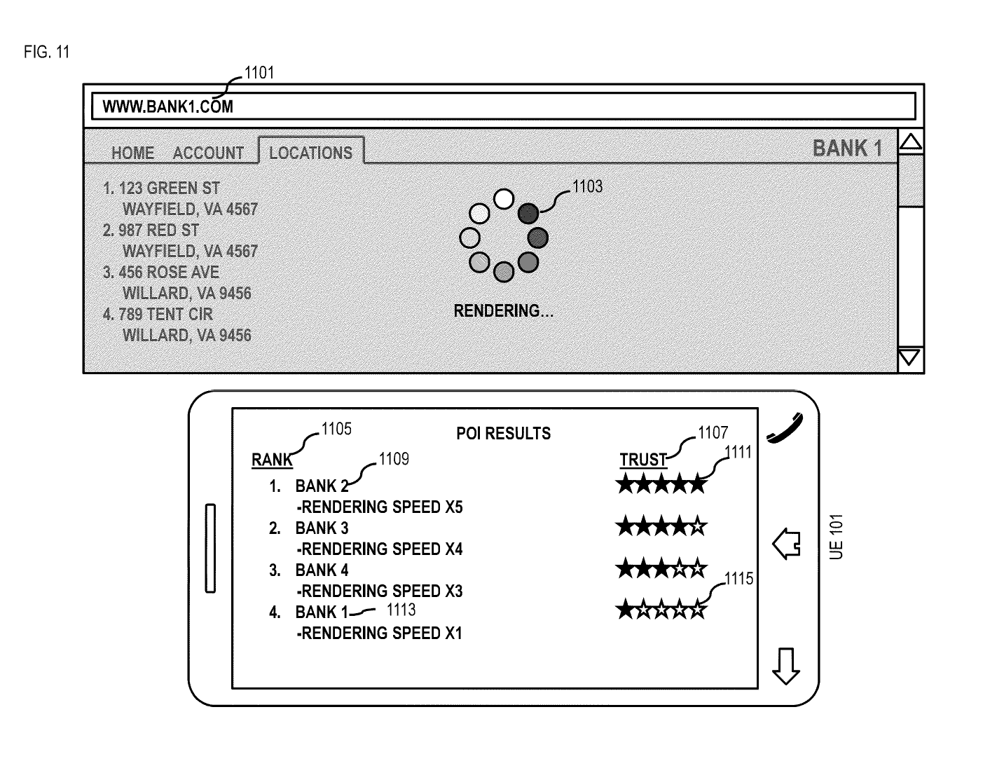

FIG. 11 is a diagram of a user interface utilized in the process of increasing or decreasing the ranking of one or more data sources based, at least in part, on the parsing and/or rendering time for at least one data from one or more data sources, according to one example embodiment. In one scenario, the evaluation platform 109 may take into consideration the parsing and/or the rendering time (1103) for data from one or more data sources (1101) for ranking (1105) and generating trust level scores (1107). In one scenario, if the attributes for one or more data are complex, the rendering time and the parsing time for such data are slower, thereby contributing to negative user experience and interaction. As a result, such data sources should be ranked lower and/or have lower trust level. In one scenario, data source for Bank 2 is ranked the highest (1109) with a high trust score (1111) because the parsing and/or the rendering speed is the highest when compared with the data sources of other banks On the other hand, the Bank 1 is ranked the lowest (1113) with very low trust score (1115) because the parsing speed and the rendering speed is the slowest.

The processes described herein for processing one or more attributes associated with extracting data from one or more data sources to cause a ranking of the one or more data sources and/or calculate one or more trust levels for the one or more data sources may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

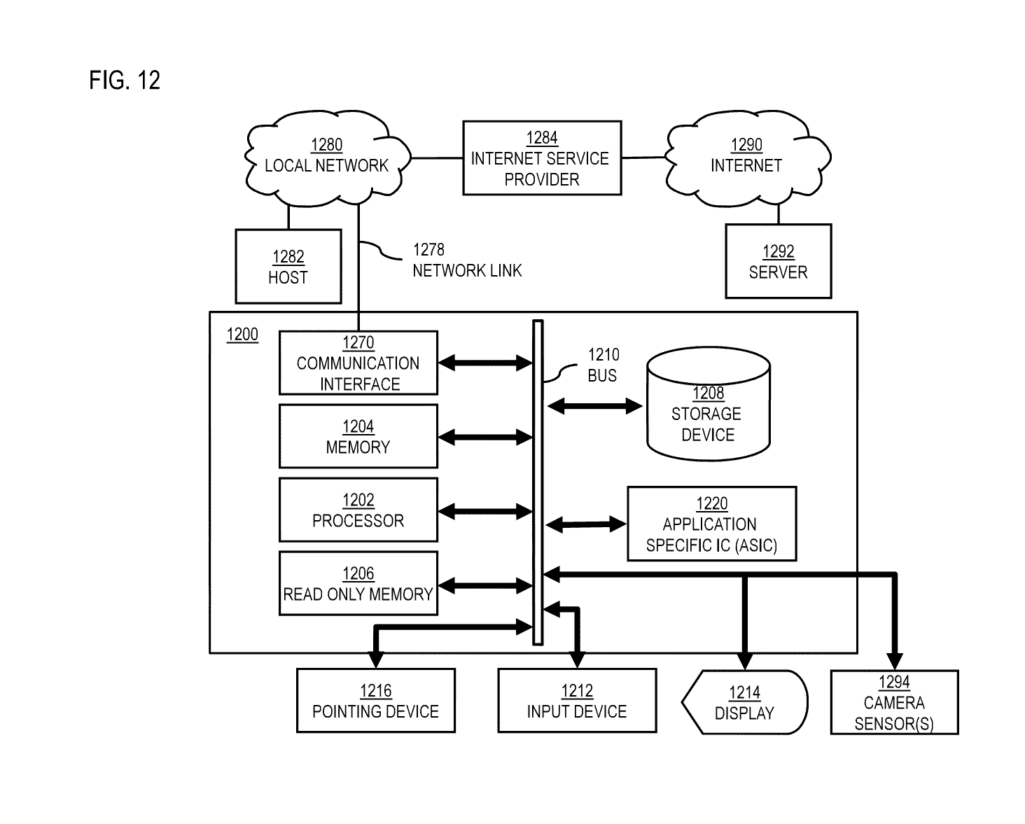

FIG. 12 illustrates a computer system 1200 upon which an embodiment of the invention may be implemented. Although computer system 1200 is depicted with respect to a particular device or equipment, it is contemplated that other devices or equipment (e.g., network elements, servers, etc.) within FIG. 12 can deploy the illustrated hardware and components of system 1200. Computer system 1200 is programmed (e.g., via computer program code or instructions) to process the one or more attributes associated with extracting data from one or more data sources to cause a ranking of the one or more data sources and/or calculate one or more trust levels for the one or more data sources as described herein and includes a communication mechanism such as a bus 1210 for passing information between other internal and external components of the computer system 1200. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1200, or a portion thereof, constitutes a means for performing one or more steps of processing the one or more attributes associated with extracting data from one or more data sources to cause a ranking of the one or more data sources and/or calculate one or more trust levels for the one or more data sources.

A bus 1210 includes one or more parallel conductors of information so that information is transferred quickly among devices coupled to the bus 1210. One or more processors 1202 for processing information are coupled with the bus 1210.

A processor (or multiple processors) 1202 performs a set of operations on information as specified by computer program code related to process the one or more attributes associated with extracting data from one or more data sources to cause a ranking of the one or more data sources and/or calculate one or more trust levels for the one or more data sources. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1210 and placing information on the bus 1210. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1202, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1200 also includes a memory 1204 coupled to bus 1210. The memory 1204, such as a random access memory (RAM) or any other dynamic storage device, stores information including processor instructions for processing one or more attributes associated with extracting data from one or more data sources to cause a ranking of the one or more data sources and/or calculate one or more trust levels for the one or more data sources. Dynamic memory allows information stored therein to be changed by the computer system 1200. RAM allows a unit of information stored at a location called a memory address to be stored and retrieved independently of information at neighboring addresses. The memory 1204 is also used by the processor 1202 to store temporary values during execution of processor instructions. The computer system 1200 also includes a read only memory (ROM) 1206 or any other static storage device coupled to the bus 1210 for storing static information, including instructions, that is not changed by the computer system 1200. Some memory is composed of volatile storage that loses the information stored thereon when power is lost. Also coupled to bus 1210 is a non-volatile (persistent) storage device 1208, such as a magnetic disk, optical disk or flash card, for storing information, including instructions, that persists even when the computer system 1200 is turned off or otherwise loses power.

Information, including instructions for processing one or more attributes associated with extracting data from one or more data sources to cause a ranking of the one or more data sources and/or calculate one or more trust levels for the one or more data sources, is provided to the bus 1210 for use by the processor from an external input device 1212, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1200. Other external devices coupled to bus 1210, used primarily for interacting with humans, include a display device 1214, such as a cathode ray tube (CRT), a liquid crystal display (LCD), a light emitting diode (LED) display, an organic LED (OLED) display, a plasma screen, or a printer for presenting text or images, and a pointing device 1216, such as a mouse, a trackball, cursor direction keys, or a motion sensor, for controlling a position of a small cursor image presented on the display 1214 and issuing commands associated with graphical elements presented on the display 1214, and one or more camera sensors 1294 for capturing, recording and causing to store one or more still and/or moving images (e.g., videos, movies, etc.) which also may comprise audio recordings. In some embodiments, for example, in embodiments in which the computer system 1200 performs all functions automatically without human input, one or more of external input device 1212, display device 1214 and pointing device 1216 may be omitted.

In the illustrated embodiment, special purpose hardware, such as an application specific integrated circuit (ASIC) 1220, is coupled to bus 1210. The special purpose hardware is configured to perform operations not performed by processor 1202 quickly enough for special purposes. Examples of ASICs include graphics accelerator cards for generating images for display 1214, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1200 also includes one or more instances of a communications interface 1270 coupled to bus 1210. Communication interface 1270 provides a one-way or two-way communication coupling to a variety of external devices that operate with their own processors, such as printers, scanners and external disks. In general the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. For wireless links, the communications interface 1270 sends or receives or both sends and receives electrical, acoustic or electromagnetic signals, including infrared and optical signals, that carry information streams, such as digital data. For example, in wireless handheld devices, such as mobile telephones like cell phones, the communications interface 1270 includes a radio band electromagnetic transmitter and receiver called a radio transceiver. In certain embodiments, the communications interface 1270 enables connection to the communication network 107 for processing one or more attributes associated with extracting data from one or more data sources to cause a ranking of the one or more data sources and/or calculate one or more trust levels for the one or more data sources to the UE 101.

The term “computer-readable medium” as used herein refers to any medium that participates in providing information to processor 1202, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1208. Volatile media include, for example, dynamic memory 1204. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer- readable medium except transmission media.

Logic encoded in one or more tangible media includes one or both of processor instructions on a computer-readable storage media and special purpose hardware, such as ASIC 1220.

Network link 1278 typically provides information communication using transmission media through one or more networks to other devices that use or process the information. For example, network link 1278 may provide a connection through local network 1280 to a host computer 1282 or to equipment 1284 operated by an Internet Service Provider (ISP). ISP equipment 1284 in turn provides data communication services through the public, world-wide packet-switching communication network of networks now commonly referred to as the Internet 1290.

A computer called a server host 1292 connected to the Internet hosts a process that provides a service in response to information received over the Internet. For example, server host 1292 hosts a process that provides information representing video data for presentation at display 1214. It is contemplated that the components of system 1200 can be deployed in various configurations within other computer systems, e.g., host 1282 and server 1292.

At least some embodiments of the invention are related to the use of computer system 1200 for implementing some or all of the techniques described herein. According to one embodiment of the invention, those techniques are performed by computer system 1200 in response to processor 1202 executing one or more sequences of one or more processor instructions contained in memory 1204. Such instructions, also called computer instructions, software and program code, may be read into memory 1204 from another computer-readable medium such as storage device 1208 or network link 1278. Execution of the sequences of instructions contained in memory 1204 causes processor 1202 to perform one or more of the method steps described herein. In alternative embodiments, hardware, such as ASIC 1220, may be used in place of or in combination with software to implement the invention. Thus, embodiments of the invention are not limited to any specific combination of hardware and software, unless otherwise explicitly stated herein.

The signals transmitted over network link 1278 and other networks through communications interface 1270, carry information to and from computer system 1200. Computer system 1200 can send and receive information, including program code, through the networks 1280, 1290 among others, through network link 1278 and communications interface 1270. In an example using the Internet 1290, a server host 1292 transmits program code for a particular application, requested by a message sent from computer 1200, through Internet 1290, ISP equipment 1284, local network 1280 and communications interface 1270. The received code may be executed by processor 1202 as it is received, or may be stored in memory 1204 or in storage device 1208 or any other non-volatile storage for later execution, or both. In this manner, computer system 1200 may obtain application program code in the form of signals on a carrier wave.

Various forms of computer readable media may be involved in carrying one or more sequence of instructions or data or both to processor 1202 for execution. For example, instructions and data may initially be carried on a magnetic disk of a remote computer such as host 1282. The remote computer loads the instructions and data into its dynamic memory and sends the instructions and data over a telephone line using a modem. A modem local to the computer system 1200 receives the instructions and data on a telephone line and uses an infra-red transmitter to convert the instructions and data to a signal on an infra-red carrier wave serving as the network link 1278. An infrared detector serving as communications interface 1270 receives the instructions and data carried in the infrared signal and places information representing the instructions and data onto bus 1210. Bus 1210 carries the information to memory 1204 from which processor 1202 retrieves and executes the instructions using some of the data sent with the instructions. The instructions and data received in memory 1204 may optionally be stored on storage device 1208, either before or after execution by the processor 1202.

FIG. 13 illustrates a chip set or chip 1300 upon which an embodiment of the invention may be implemented. Chip set 1300 is programmed to process the one or more attributes associated with extracting data from one or more data sources to cause a ranking of the one or more data sources and/or calculate one or more trust levels for the one or more data sources as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1300 can be implemented in a single chip. It is further contemplated that in certain embodiments the chip set or chip 1300 can be implemented as a single “system on a chip.” It is further contemplated that in certain embodiments a separate ASIC would not be used, for example, and that all relevant functions as disclosed herein would be performed by a processor or processors. Chip set or chip 1300, or a portion thereof, constitutes a means for performing one or more steps of providing user interface navigation information associated with the availability of functions. Chip set or chip 1300, or a portion thereof, constitutes a means for performing one or more steps of processing the one or more attributes associated with extracting data from one or more data sources to cause a ranking of the one or more data sources and/or calculate one or more trust levels for the one or more data sources.

In one embodiment, the chip set or chip 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1300 includes merely one or more processors and some software and/or firmware supporting and/or relating to and/or for the one or more processors.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to process the one or more attributes associated with extracting data from one or more data sources to cause a ranking of the one or more data sources and/or calculate one or more trust levels for the one or more data sources. The memory 1305 also stores the data associated with or generated by the execution of the inventive steps.

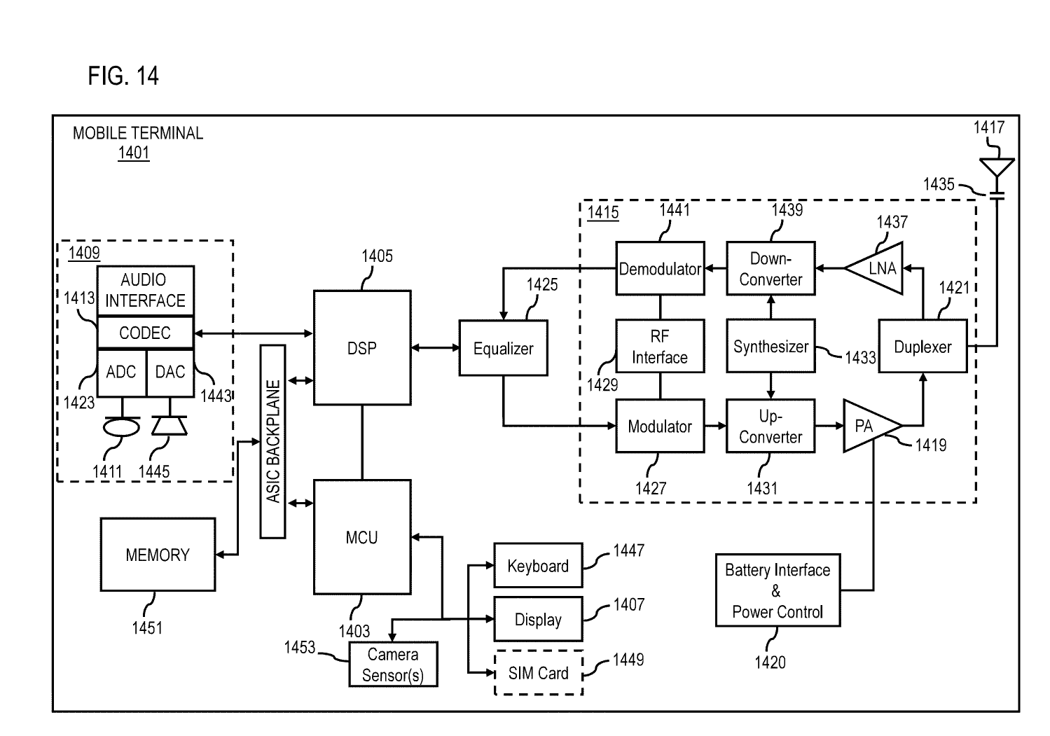

FIG. 14 is a diagram of exemplary components of a mobile terminal (e.g., handset) for communications, which is capable of operating in the system of FIG. 1, according to one embodiment. In some embodiments, mobile terminal 1401, or a portion thereof, constitutes a means for performing one or more steps of processing one or more attributes associated with extracting data from one or more data sources to cause a ranking of the one or more data sources and/or calculate one or more trust levels for the one or more data sources. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1403, a Digital Signal Processor (DSP) 1405, and a receiver/transmitter unit including a microphone gain control unit and a speaker gain control unit. A main display unit 1407 provides a display to the user in support of various applications and mobile terminal functions that perform or support the steps of processing one or more attributes associated with extracting data from one or more data sources to cause a ranking of the one or more data sources and/or calculate one or more trust levels for the one or more data sources. The display 1407 includes display circuitry configured to display at least a portion of a user interface of the mobile terminal (e.g., mobile telephone). Additionally, the display 1407 and display circuitry are configured to facilitate user control of at least some functions of the mobile terminal. An audio function circuitry 1409 includes a microphone 1411 and microphone amplifier that amplifies the speech signal output from the microphone 1411. The amplified speech signal output from the microphone 1411 is fed to a coder/decoder (CODEC) 1413.

A radio section 1415 amplifies power and converts frequency in order to communicate with a base station, which is included in a mobile communication system, via antenna 1417. The power amplifier (PA) 1419 and the transmitter/modulation circuitry are operationally responsive to the MCU 1403, with an output from the PA 1419 coupled to the duplexer 1421 or circulator or antenna switch, as known in the art. The PA 1419 also couples to a battery interface and power control unit 1420.

In use, a user of mobile terminal 1401 speaks into the microphone 1411 and his or her voice along with any detected background noise is converted into an analog voltage. The analog voltage is then converted into a digital signal through the Analog to Digital Converter (ADC) 1423. The control unit 1403 routes the digital signal into the DSP 1405 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1425 for compensation of any frequency-dependent impairments that occur during transmission though the air such as phase and amplitude distortion. After equalizing the bit stream, the modulator 1427 combines the signal with a RF signal generated in the RF interface 1429. The modulator 1427 generates a sine wave by way of frequency or phase modulation. In order to prepare the signal for transmission, an up-converter 1431 combines the sine wave output from the modulator 1427 with another sine wave generated by a synthesizer 1433 to achieve the desired frequency of transmission. The signal is then sent through a PA 1419 to increase the signal to an appropriate power level. In practical systems, the PA 1419 acts as a variable gain amplifier whose gain is controlled by the DSP 1405 from information received from a network base station. The signal is then filtered within the duplexer 1421 and optionally sent to an antenna coupler 1435 to match impedances to provide maximum power transfer. Finally, the signal is transmitted via antenna 1417 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1401 are received via antenna 1417 and immediately amplified by a low noise amplifier (LNA) 1437. A down-converter 1439 lowers the carrier frequency while the demodulator 1441 strips away the RF leaving only a digital bit stream. The signal then goes through the equalizer 1425 and is processed by the DSP 1405. A Digital to Analog Converter (DAC) 1443 converts the signal and the resulting output is transmitted to the user through the speaker 1445, all under control of a Main Control Unit (MCU) 1403 which can be implemented as a Central Processing Unit (CPU).

The MCU 1403 receives various signals including input signals from the keyboard 1447. The keyboard 1447 and/or the MCU 1403 in combination with other user input components (e.g., the microphone 1411) comprise a user interface circuitry for managing user input. The MCU 1403 runs a user interface software to facilitate user control of at least some functions of the mobile terminal 1401 to process the one or more attributes associated with extracting data from one or more data sources to cause a ranking of the one or more data sources and/or calculate one or more trust levels for the one or more data sources. The MCU 1403 also delivers a display command and a switch command to the display 1407 and to the speech output switching controller, respectively. Further, the MCU 1403 exchanges information with the DSP 1405 and can access an optionally incorporated SIM card 1449 and a memory 1451. In addition, the MCU 1403 executes various control functions required of the terminal. The DSP 1405 may, depending upon the implementation, perform any of a variety of conventional digital processing functions on the voice signals. Additionally, DSP 1405 determines the background noise level of the local environment from the signals detected by microphone 1411 and sets the gain of microphone 1411 to a level selected to compensate for the natural tendency of the user of the mobile terminal 1401.

The CODEC 1413 includes the ADC 1423 and DAC 1443. The memory 1451 stores various data including call incoming tone data and is capable of storing other data including music data received via, e.g., the global Internet. The software module could reside in RAM memory, flash memory, registers, or any other form of writable storage medium known in the art. The memory device 1451 may be, but not limited to, a single memory, CD, DVD, ROM, RAM, EEPROM, optical storage, magnetic disk storage, flash memory storage, or any other non- volatile storage medium capable of storing digital data.

An optionally incorporated SIM card 1449 carries, for instance, important information, such as the cellular phone number, the carrier supplying service, subscription details, and security information. The SIM card 1449 serves primarily to identify the mobile terminal 1401 on a radio network. The card 1449 also contains a memory for storing a personal telephone number registry, text messages, and user specific mobile terminal settings.

Further, one or more camera sensors 1453 may be incorporated onto the mobile station 1401 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of the one or more attributes associated with extracting data from one or more data sources; and
a processing of the one or more attributes to cause, at least in part, (a) a ranking of the one or more data sources, (b) a calculation of one or more trust levels for the one or more data sources, or (c) a combination thereof.

2. A method of claim 1, wherein the one or more attributes relate, at least in part, to an ease of extracting the data from the data sources, a quality of the data, or a combination thereof.

3. A method of claim 2, wherein the (1) data and/or (2) information and/or (3) at least one signal are further based, at least in part, on the following:
an application of one or more parameters to determine ease of extracting the data from one or more data sources,
wherein one or more parameters include, at least in part, a parsing speed for one or more data, a rendering speed for one or more data, or a combination thereof.

4. A method of claim 1, wherein the (1) data and/or (2) information and/or (3) at least one signal are further based, at least in part, on the following:
at least one determination of rankings for one or more data sources based, at least in part, on predefined quality rules,
wherein predetermined quality rules include, at least in part, accuracy of the one or more data, the relevancy of the one or more data, timely updates of the one or more data sources, or a combination thereof.

5. A method of claim 1, wherein the (1) data and/or (2) information and/or (3) at least one signal are further based, at least in part, on the following:
calculation of one or more trust levels based, at least in part, on reputation information, popularity information, or a combination thereof; and
a collection of data based, at least in part, on the context of the trust levels.

6. A method of claim 1, wherein the (1) data and/or (2) information and/or (3) at least one signal are further based, at least in part, on the following:
an increase or a decrease in a ranking, a trust level, or a combination thereof based, at least in part, on occurrence of inaccurate information, retrieval of one or more data from at least one mobile device, location proximity information, contextual information, or a combination thereof.

7. A method of claim 1, wherein the (1) data and/or (2) information and/or (3) at least one signal are further based, at least in part, on the following:
a categorization of one or more data sources based, at least in part, on the ranking, the trust levels, or a combination thereof ensuring increased relevancy of data to the one or more users; and
at least one determination of an order for presenting the one or more data sources based, at least in part, on the categorization.

8. A method of claim 1, wherein the (1) data and/or (2) information and/or (3) at least one signal are further based, at least in part, on the following:
a processing of one or more data to determine accuracy of the information; and
a notification to one or more data sources for data updates.

9. A method of claim 8, wherein the (1) data and/or (2) information and/or (3) at least one signal are further based, at least in part, on the following:
a matching of one or more data extracted from one or more data sources; and
at least one determination of a rank, a trust level, or a combination thereof for at least one data source based, at least in part, on the matching.

10. A method of claim 1, wherein the (1) data and/or (2) information and/or (3) at least one signal are further based, at least in part, on the following:
a comparison between one or more data sources to generate a unified score to determine a ranking, a trust level, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine one or more attributes associated with extracting data from one or more data sources; and
process and/or facilitate a processing of the one or more attributes to cause, at least in part, (a) a ranking of the one or more data sources, (b) a calculation of one or more trust levels for the one or more data sources, or (c) a combination thereof.

12. An apparatus of claim 11, wherein the one or more attributes relate, at least in part, to an ease of extracting the data from the data sources, a quality of the data, or a combination thereof.

13. An apparatus of claim 12, wherein the apparatus is further caused to:
cause, at least in part, an application of one or more parameters to determine ease of extracting the data from one or more data sources,
wherein one or more parameters include, at least in part, a parsing speed for one or more data, a rendering speed for one or more data, or a combination thereof.

14. An apparatus of claim 11, wherein the apparatus is further caused to:
determine, at least in part, rankings for one or more data sources based, at least in part, on predefined quality rules,
wherein predetermined quality rules include, at least in part, accuracy of the one or more data, the relevancy of the one or more data, timely updates of the one or more data sources, or a combination thereof.

15. An apparatus of claim 11, wherein the apparatus is further caused to:
cause, at least in part, calculation of one or more trust levels based, at least in part, on reputation information, popularity information, or a combination thereof; and
cause, at least in part, a collection of data based, at least in part, on the context of the trust levels.

16. An apparatus of claim 11, wherein the apparatus is further caused to:
cause, at least in part, an increase or a decrease in a ranking, a trust level, or a combination thereof based, at least in part, on occurrence of inaccurate information, retrieval of one or more data from at least one mobile device, location proximity information, contextual information, or a combination thereof.

17. An apparatus of claim 11, wherein the apparatus is further caused to:
cause, at least in part, a categorization of one or more data sources based, at least in part, on the ranking, the trust levels, or a combination thereof ensuring increased relevancy of data to the one or more users; and
determine an order for presenting the one or more data sources based, at least in part, on the categorization.

18. An apparatus of claim 11, wherein the apparatus is further caused to:
process and/or facilitate a processing of one or more data to determine accuracy of the information;
cause, at least in part, a notification to one or more data sources for data updates.

19. An apparatus of claim 18, wherein the apparatus is further caused to:
cause, at least in part, a matching of one or more data extracted from one or more data sources; and
determine a rank, a trust level, or a combination thereof for at least one data source based, at least in part, on the matching.

20. An apparatus of claim 11, wherein the apparatus is further caused to:
cause, at least in part, a comparison between one or more data sources to generate a unified score to determine a ranking, a trust level, or a combination thereof.

21.-48. (canceled)
